(19) United States
(12) Patent Application Publication
(10) Pub. No.: US 2017/0008496 A1
(43) Pub. Date: Jan. 12, 2017

(54) VEHICLE CLEANING APPARATUS

(71) Applicants: AEROPAIR LTD, Renfrew (GB); ECOGREEN PLANT HIRE, Northwich Cheshire (GB)

(72) Inventors: STEPHEN JOSEPH FINDLAY, RENFREW (GB); STUART JOHN SOUTHERN, NORTHWICH CHESHIRE (GB)

(21) Appl. No.: 15/119,657

(22) PCT Filed: Feb. 16, 2015
(86) PCT No.: PCT/EP2015/053229

§ 371 Date: Aug. 17, 2016

(30) Foreign Application Priority Data
Feb. 17, 2014 (GB) 1402757.7

(51) Int. Cl. B60S 3/04

(52) U.S. Cl. CPC B60S 3/04

(57) ABSTRACT

In a particular embodiment, a vehicle cleaning apparatus includes a trackway comprising a plurality of transversely extending members which are spaced longitudinally along the trackway. The trackway comprises a raised section comprising a first set of the transversely extending members, and a ramp arranged to allow the vehicle to travel between the raised section and a lower end of the ramp. The ramp comprises a second set of the transversely extending members. The first set of the transversely extending members comprises a first subset and a second subset of the transversely extending members. The transversely extending members of the first subset are raised with respect to those in the second subset. The second set of the transversely extending members comprises a third subset and a fourth subset of the transversely extending members. The transversely extending members of the third subset are raised with respect to those in the fourth subset.

### CLAIM OF PRIORITY

This application is a 371 of International Application EP2015/053229, filed Feb. 16, 2015, claiming priority from GB Patent Application 1402757.7, filed Feb. 17, 2014.

### FIELD OF THE INVENTION

The present disclosure relates to a vehicle cleaning apparatus.

### BACKGROUND

It is becoming increasingly common for building construction sites to try to limit the effect that the construction site has on the surrounding area whilst construction is taking place. For example, trucks or lorries leaving the site may unintentionally carry dirt, sand, mud or other debris off site, for example on the tyres and undercarriage, and deposit it on the surrounding roadway. This may cause a problem for local traffic. Furthermore, the build-up of dirt on the vehicle, particularly underneath or up the sides may lead to reduced operational life, or increase the need for servicing. The build-up of dirt or debris in tyres may also reduce the operational lifespan of a tyre and may lead to sudden failure of the tyre at high speed thus causing accidents.

Various techniques are known for helping to clean a vehicle. For example, a vehicle may drive through a water bath which may help wash some dirt from the tyres. However, this typically does not help clean the body of the vehicle and some dirt may remain lodged in the treads of the tyres. The present disclosure seeks to address these problems. The present disclosure seeks to provide an improved vehicle cleaning apparatus.

In a first aspect, there is provided a vehicle cleaning apparatus for removing dirt from a vehicle as the vehicle drives over the apparatus, the apparatus comprising: a trackway comprising a plurality of transversely extending members which are spaced longitudinally along the trackway, the trackway comprising: a raised section comprising a first set of the transversely extending members; a ramp arranged to allow the vehicle to travel between the raised section and a lower end of the ramp, the ramp comprising a second set of the transversely extending members; in which: the first set of the transversely extending members comprises a first subset and a second subset of the transversely extending members, in which the transversely extending members of the first subset are raised with respect to those in the second subset; and the second set of the transversely extending members comprises a third subset and a fourth subset of the transversely extending members, in which the transversely extending members of the third subset are raised with respect to those in the fourth subset; such that as a vehicle drives onto the ramp, the vehicle starts to be vibrated by the second set of the transversely extending members, with different modes of vibration being caused by the height difference that arises from the members in the third subset being raised with respect to those in the fourth subset, and as the vehicle drives onto and across the raised section, other modes of vibration are caused by the height difference that arises from the members in the first subset being raised with respect to those in the second subset. Thereby, there is provided an approach for cleaning of a vehicle without the use of water. Also, there is provided an approach for cleaning of a vehicle without the use of a power supply additional to a motive force power supply of the vehicle being cleaned.

For example, as the vehicle drives onto the ramp, the tyres and hence the vehicle body start to be vibrated by the second set of the transversely extending members, with different modes of vibration being caused by the height difference that arises from the members in the third subset being raised with respect to those in the fourth subset. This helps dirt and debris to start to be dislodged from the vehicle. As the vehicle drives onto and across the raised section, other modes of vibration are caused by the height difference that arises from the members in the first subset being raised with respect to those in the second subset, thus helping shake dirt from the vehicle and dislodge it from the treads of the tyres. Furthermore, the transversely extending members may help the tyre tread to open up where it contacts the members, thus helping anything trapped in the tyre tread to become dislodged.

### BRIEF SUMMARY OF THE INVENTION

Various other aspects and features of the invention are defined in the appended claims.

### BRIEF DESCRIPTION OF THE DRAWINGS

Examples of the disclosure will now be described by way of example with reference to the accompanying drawings, throughout which like references refer to like parts, and in which:

FIG. 1 schematically illustrates a vehicle cleaning apparatus;

FIGS. 2a-2d schematically illustrate a raised section of the vehicle cleaning apparatus;

FIGS. 3a-3d schematically illustrate a ramp of the vehicle cleaning apparatus; and

FIGS. 4a-4c schematically illustrate side barriers of the vehicle cleaning apparatus.

### DETAILED DESCRIPTION OF THE EMBODIMENTS

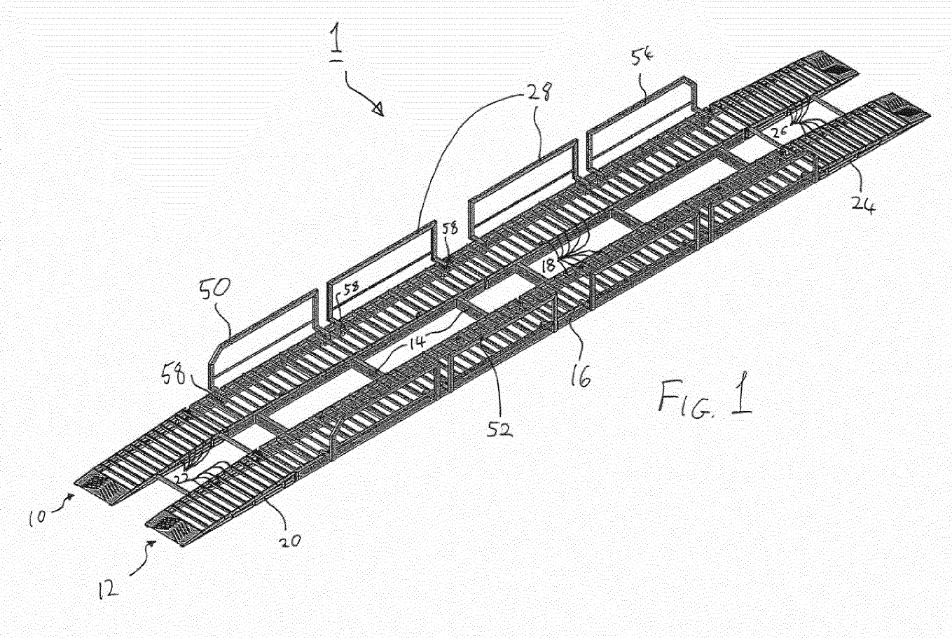

FIG. 1 schematically illustrates a vehicle cleaning apparatus 1 for removing dirt from a vehicle as the vehicle drives over the apparatus. The apparatus 1 comprises a trackway over which a vehicle may drive. The trackway comprises a first track 10 and a second track 12 (a pair of tracks) in generally parallel spaced relation to each other. Typically the tracks 10 and 12 are spaced so as to correspond to the pitch between the vehicles wheels, e.g. depending on the type of vehicle that the apparatus 1 is designed for. However, it will be appreciated that the tracks 10 and 12 may typically be wider than the width of an individual tyre so as to provide some tolerance for vehicles with different wheel spacing and/or differing numbers of wheels per axle. The trackway comprises cross struts (e.g. cross struts 14) which cooperate with the track 10 and 12 to hold them in generally spaced parallel relation. Typically the cross struts are welded to the tracks 10 and 12 as this helps improve the longevity and robustness of the apparatus. However, it will be appreciated that other bonding methods such as adhesives or bolts and through holes could be used, although it will be appreciate that this may be less preferable depending on the size of the apparatus and the vehicles it is intended to be used with.

The trackway comprises a plurality of transversely extending members (transverse members) which are spaced longitudinally along the trackway. In examples, the transverse members may be arranged at different heights from each other so as to cause different modes of vibration as the vehicle drives over the apparatus to help dislodge different types of dirt. This will be described in more detail later below. In examples, one or more of the raised section 16 and the ramp 20 are open beneath to allow matter (such as dirt and debris) to fall between the transversely extending members. This can then be removed manually, e.g. with a suitable implement such as a rake. Thereby, there is provided an approach for cleaning of a vehicle without the use of water. Also, there is provided an approach for cleaning of a vehicle without the use of a power supply additional to a motive force power supply of the vehicle being cleaned.

In examples, an upper portion of the cross section of the transverse members is substantially v-shaped with the apex directed upwards for making line contact with the tyres of the vehicle. As the vehicle drives over the transverse members, the v-shaped profile helps open up the tread of the tyres by elastic deformation of the tyre where in contact with the transverse members. This helps any matter stuck in the tyre tread to be dislodged and fall out of the tread.

The trackway comprises a raised section 16 comprising a first set of the transversely extending members (such as transverse members 18), and a ramp 20 arranged to allow the vehicle to travel between the raised section 16 and a lower end of the ramp 20. The ramp comprises a second set of the transversely extending members (such as transverse members 22). In examples, the ramp 20 is arranged to act as one of a lead-on ramp arranged so that the vehicle can drive onto the raised section 16 via the lead-on ramp and a lead-off ramp arranged so that the vehicle can drive off the raised section 16 via the lead-off ramp.

In examples, the apparatus comprises a second ramp 24 which can act as a lead-on ramp and/or lead-off ramp as appropriate. The second ramp 24 comprises a third set of transversely extending members (such as transverse members 26). For example, the ramp 20 can act as a lead-on ramp with the ramp 24 acting as a lead-off ramp or vice versa. It will be appreciated that a vehicle could drive onto the raised section via the ramp 20 or ramp 24 and reverse off the same way. In other words, the same ramp could act as both a lead-on ramp and/or a lead-off ramp. However, it will be appreciated that it is generally preferable to operate the apparatus in a configuration where the vehicle drives onto the raised section 16 via a lead-on ramp and off the raised section 16 via a lead-off ramp so as to reduce the likelihood of the vehicles wheels travelling through any dirt or debris deposited on the road before the lead-on ramp which could occur where the vehicle reverses off the same way as it went onto the raised section.

Although the example in FIG. 1 illustrates two ramps (ramp 20 and ramp 24) it will be appreciated that one ramp may be used (for example by omitting one of the ramps), with entry or exit onto the raised section 16 being accomplished by the vehicle driving on and reversing, or by other means for exit or entry such as an end of the raised section 16 abutting a dirt ramp or other feature which allows the vehicle to drive on or off the raised section.

In examples, the trackway comprises side barriers (such as side barriers 28, 50, 52, and 54) for inhibiting movement of the vehicle off the sides of the trackway. In other examples, the side barriers may be omitted. For example, the side barriers may be omitted at the user's discretion. In some examples, the side barriers are removably attachable to the trackway. The side barriers will be described in more detail later below.

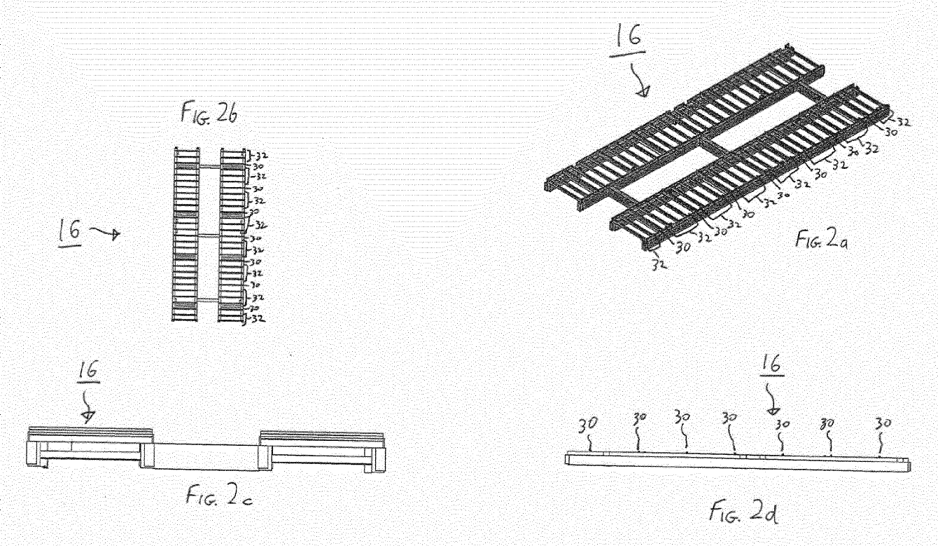

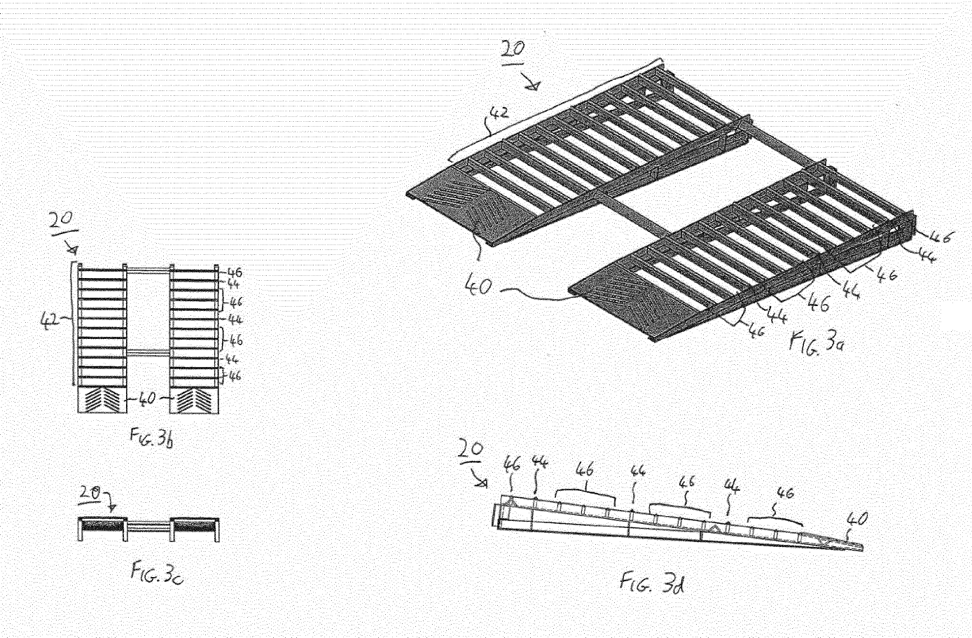

The raised section 16 and the ramp 20 will now be described in more detail with reference to FIGS. 2a-2d and 3a-3d.

FIG. 2a schematically illustrates a perspective view of the raised section 16. FIG. 2b schematically illustrates a plan view of the raised section 16. FIG. 2c schematically illustrates a transverse cross section through the raised section 16. FIG. 2d schematically illustrates a longitudinal cross section of the raised section 16.

Referring to FIGS. 2a-2d, the first set of the transversely extending members comprises a first subset 30 and a second subset 32 of the transversely extending members. The transversely extending members of the first subset 30 are raised with respect to those in the second subset 32. In examples, the members in the first subset 30 are regularly arranged along the raised section 16. For example, each member in the first subset 30 is separated from another member in the first subset 30 by one or more members in the second subset 32.

In the example shown in FIG. 2, each member in the first subset 30 is separated from another member in the first subset 30 by three members in the second subset 32. However, in other examples, each member in the first subset 30 is separated from another member in the first subset 30 by four members in the second subset 32. It has been found that this configuration is particularly effective at helping to remove dirt and debris from a vehicle. However, it will be appreciated that other numbers of members in the second subset 32 could be used to separate those in the first subset 30. It will also be appreciated that the members in the first subset 30 could be grouped together, for example in pairs, threes, etc. with members of the second subset 32 separating each group of members in the first subset 30. Additionally it will be appreciated that the members in the first subset could be randomly arranged along the raised section or a combination of regular and random arrangements could be used. Furthermore it will be appreciated that different configurations of transverse members may provide different cleaning effectiveness. For example, as mentioned above, the configuration in which each member in the first subset 30 is separated from another member in the first subset 30 by four members in the second subset 32 has been found to offer particularly effective cleaning action.

In examples, the members in the first subset 30 are raised between 35 mm to 45 mm with respect to the members in the second subset 32, although it will be appreciate that other values could be used. However, it has been found that a range of 35 mm to 45 mm is particularly advantageous for helping to remove dirt and debris from vehicles. In particular, a difference of 40 mm (i.e. the members in the first subset 30 are raised by 40 mm with respect to the members in the second subset 32) has been found to be particularly effective.

The ramp 20 will now be described with reference to FIGS. 3a-3d. FIG. 3a schematically illustrates a perspective view of the ramp 20. FIG. 3b schematically illustrates a plan view of the ramp 20. FIG. 3c schematically illustrates a transverse cross section through the ramp 20. FIG. 3d schematically illustrates a longitudinal cross section of the ramp 20.

The ramp 20 comprises a treaded portion 40 and a transverse member portion 42 in the longitudinal direction which comprises the second set of transversely extending members. The treaded portion 40 comprises a tread pattern for helping the tyres of the vehicle grip the ramp 20 and assist the vehicle driving onto the apparatus. In examples, the tread pattern comprises raised line elements arranged in a chevron pattern, although it will be appreciated that any other suitable tread pattern could be used. In other examples, the treaded portion 40 may be omitted, although this may be less preferable because this could lead to reduced traction and hence make it more difficult for a vehicle to drive onto the ramp.

Referring to FIGS. 3a-3d, the second set of the transversely extending members comprises a third subset 44 and a fourth subset 46 of the transversely extending members. The transversely extending members of the third subset 44 are raised with respect to those in the fourth subset 46. In examples, the members in the third subset 44 are regularly arranged along the ramp 20. For example, each member in the third subset 44 is separated from another member in the third subset 44 by one or more members in the fourth subset 46.

In the example shown in FIG. 3, each member in the third subset 44 is separated from another member in the third subset 44 by three members in the fourth subset 46. This configuration has been found to offer particularly effective cleaning action.

However, in other examples, each member in the third subset 44 is separated from another member in the third subset 44 by four members in the fourth subset 46, although it will be appreciated that other numbers of members in the fourth subset 46 could be used to separate those in the third subset 44. It will also be appreciated that the members in the third subset 44 could be grouped together, for example in pairs, threes, etc. with members of the fourth subset 46 separating each group of members in the third subset 44. Additionally it will be appreciated that the members in the third subset could be randomly arranged along the raised section or a combination of regular and random arrangements could be used. Furthermore it will be appreciated that different configurations of transverse members may provide different cleaning effectiveness.

The second ramp 24 may have the same configuration as the ramp 20 or it may have a different configuration. As discussed below, in some examples, the second ramp 24 has the same configuration as the ramp 20 as this helps allow the ramps to be used in a modular manner so that the apparatus can, for example be used bi-directionally whilst offering substantially the same cleaning action. This also helps reduce manufacturing costs.

In examples, the third set of the transversely extending members comprises a fifth subset and a sixth subset of the transversely extending members. The transversely extending members of the fifth subset are raised with respect to those in the sixth subset. In examples, the members in the fifth subset are regularly arranged along the ramp 24. For example, each member in the fifth subset is separated from another member in the fifth subset by one or more members in the sixth subset.

In examples, each member in the fifth subset is separated from another member in the fifth subset by three members in the sixth subset. However, in other examples, each member in the fifth subset is separated from another member in the fifth subset by four members in the sixth subset, although it will be appreciated that other numbers of members in the sixth subset could be used to separate those in the fifth subset. It will also be appreciated that the members in the fifth subset could be grouped together, for example in pairs, threes, etc. with members of the sixth subset separating each group of members in the fifth subset. Additionally it will be appreciated that the members in the fifth subset could be randomly arranged along the raised section or a combination of regular and random arrangements could be used. Furthermore it will be appreciated that different configurations of transverse members may provide different cleaning effectiveness.

In some examples, the height difference between the members in the third subset 44 and the members in the fourth subset 46 is the same as the height difference between the members in the fifth subset and the members in the sixth subset. In other words, in some examples, the ramp 20 and the second ramp 24 have the same configuration of transverse members as each other. This may be of use where the vehicle cleaning apparatus may be used bi-directionally, for example for vehicles entering and exiting a site by the same route because the ramps should have the same cleaning action without dependence on the direction that the vehicle drives over the apparatus. Having the ramp 20 and the second ram 24 configured the same also helps reduce manufacturing costs.

In other examples, the height difference between the members in the third subset 44 and the members in the fourth subset 46 is different from the height difference between the members in the fifth subset and the members in the sixth subset. In other words, in these examples, the ramp 20 and the ramp 24 have a different configuration from each other. For example, the height difference between the transverse members on the lead-on ramp could be arranged to be greater than the height difference between the transverse members on the lead-off ramp so as to provide larger amplitude vibrations on lead to help start the dirt to be dislodged.

Additionally, it will be appreciated that the ramp 20 and the ramp 24 could have different arrangements of transverse members for example to provide different frequencies of vibration as the vehicle drives onto the raised section 16 and then off the raised section 16. However, the examples described herein with reference to FIGS. 1 to 4 have been found to offer particularly effective cleaning action.

In some examples, an amount the members in the first subset 30 are raised with respect to the members in the second subset 32 is different from the height difference between the members in the third subset 44 and the fourth subset 46. In other words, the transverse members of the raised section 20 could have a different height difference between them from the transverse members of the ramp 20 and/or the ramp 24. However, it will be appreciated that they could use the same height difference as each other.

In some examples, the amount the members in the first subset 30 is raised with respect to the members in the second subset 32 is greater than the height difference between the members in the third subset 44 and the fourth subset 46. This may help provide a greater cleaning action while the vehicle drives along the raised section 20.

Typically, in examples, the transverse members are spaced apart from each other by 219 mm with a tolerance of +/−1 mm. These values have been found to offer effective cleaning action, although it will be appreciated that other values and tolerances could be used. The distance between the raised transverse members is dependent on the pitch between the transverse members. For example, where the members in the first subset 30 are spaced apart from each other by 4 members in the second subset, the distance between the members in the first subset is 1095 mm. The transverse members of the ramp 20 and the ramp 24 may have the same spacing as those of the raised section, or they can be different from each other.

Broadly speaking, in examples the apparatus is configured to generate different frequencies of vibration of the vehicle depending on the vehicle speed as the vehicle travels along the trackway. Typically a first frequency is associated with the spacing between each of the transverse members and a second frequency associated with the spacing between the transverse members that are raised (for example those of the first subset, third subset and/or fifth subset).

The amplitude of vibration of the second frequency is associated with the height difference between the transverse members. The amplitude of vibration of the first frequency should depend at least on the tyre radius and the spacing between the transverse members and hence how much each tyre is displaced vertically as it crosses the trackway. It is thought that smaller pieces of matter (e.g. dirt and debris) having a smaller mass and hence a higher natural frequency of vibration (resonant frequency in a simplistic mass-spring model) are dislodged by higher frequencies, whereas larger matter (e.g. dirt and debris) should be dislodged by lower frequencies. Therefore, by having transverse members which are arranged at different heights, examples of the disclosure may help provide a more effective cleaning action by assisting in dislodging different sizes and types of matter due to the different modes of vibration as the vehicle travels over the apparatus. Thereby, there is provided an approach for cleaning of a vehicle without the use of water. Also, there is provided an approach for cleaning of a vehicle without the use of a power supply additional to a motive force power supply of the vehicle being cleaned.

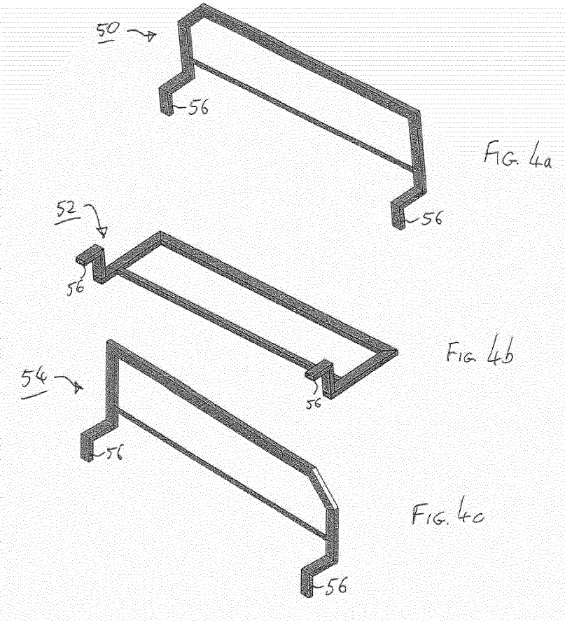

The side barriers 28 will now be described in more detail with reference to FIGS. 4a-4c. FIG. 4a schematically illustrates a side barrier for use towards the middle of the raised section 16. FIGS. 4b and $c schematically illustrate side barriers for use at the ends of the raised section. For example, referring to FIG. 1, the side barrier shown in FIG. 4a corresponds with side barrier 50, the side barrier shown in FIG. 4b corresponds with side barrier 52, and the side barrier shown in FIG. 4c corresponds with side barrier 54.

In examples, the side barriers comprise a plurality of welded box section metal tubes. In examples, the box section metal tubes of the side barriers are welded together so as to present a substantially smooth face towards the vehicle when the vehicle drives along the trackway. This helps to reduce damage to the apparatus and the vehicle should the vehicle come into contact with the side barriers. Additionally, the box section metal tubes of the side barriers are selected to have a wall thickness of between 4-6 mm so that the side barriers can deform and absorb energy from an impact by the vehicle and reduce the likelihood that the vehicle will fall off the trackway. However, it will be appreciated that other materials and construction methods could be used.

In examples, the trackway comprises a plurality of brackets (such as brackets 58) along the sides of the trackway arranged so that a portion 56 of the side barriers can be slotted into the brackets to mount the side barriers on the trackway. This helps facilitate easy mounting and removal of the side barriers, as well as helping reduce maintenance with respect to more traditional crash barrier systems attached with bolts (such as that manufactured by Armco (ID). In examples, the brackets are mounted on the inside of the trackway on the outer side of each track 10 and 12.

In some examples, the apparatus comprises modular sections. For example, the trackway can be formed from modular sections so that its length can be modified on site by addition or removal of the sections. In examples, the raised section is formed from modular sections corresponding to an integer number of transverse members in the longitudinal direction. The ramps 20 and 24 can also be considered to be modular sections. In examples, the modular sections cooperate with each other via a hook and bracket arrangement to hold the sections together. This arrangement may help reduce the likelihood that a ramp could become detached from the raised section 16 or become displaced from its desired position. It will be appreciated that the modular section could be bolted together, or other suitable attachment systems could be used for holding the modular sections together. However, bolting the modular sections together may cause the bolts to shear during repeated use of the apparatus and then fall out causing the modular sections to become detached from each other or displaced with respect to their desired position.

In examples, each modular section is formed from hot rolled mild steel which is welded together, but it will be appreciated that other metals and construction methods could be used.

It will be appreciated that the features of one or more of any of the different examples described above may be combined together as appropriate with changes as appropriate which will be apparent to the skilled person from the present disclosure.

Insofar as various examples have been described with reference to the present disclosure, it will be appreciated that various modifications and alterations may be made without departing from the spirit and scope of the invention as defined in the appended claims.

1. A vehicle cleaning apparatus for removing dirt from a vehicle as the vehicle drives over the apparatus, the apparatus comprising:
a trackway comprising a plurality of transversely extending members which are spaced longitudinally along the trackway, the trackway comprising:
a raised section comprising a first set of the transversely extending members;
a ramp arranged to allow the vehicle to travel between the raised section and a lower end of the ramp, the ramp comprising a second set of the transversely extending members;
in which:
the first set of the transversely extending members comprises a first subset and a second subset of the transversely extending members, in which the transversely extending members of the first subset are raised with respect to those in the second subset; and
the second set of the transversely extending members comprises a third subset and a fourth subset of the transversely extending members, in which the transversely extending members of the third subset are raised with respect to those in the fourth subset;
such that as a vehicle drives onto the ramp, the vehicle starts to be vibrated by the second set of the transversely extending members, with different modes of vibration being caused by the height difference that arises from the members in the third subset being raised with respect to those in the fourth subset, and as the vehicle drives onto and across the raised section, other modes of vibration are caused by the height difference that arises from the members in the first subset being raised with respect to those in the second subset.

2. An apparatus according to claim 1, in which the members in the first subset are regularly arranged along the raised section.

3. An apparatus according to claim 2, in which each member in the first subset is separated from another member in the first subset by one or more members in the second subset.

4. An apparatus according to claim 3, in which the each member in the first subset is separated from another member in the first subset by four members in the second subset.

5. An apparatus according to claim 1, in which the members in the first subset are arranged randomly along the raised section.

6. An apparatus according to any preceding claim, in which the members in the third subset are regularly arranged along the ramp.

7. An apparatus according to claim 6, in which each member in the third subset is separated from another member in the third subset by one or more members in the fourth subset.

8. An apparatus according to claim 7, in which the each member in the third subset is separated from another member in the third subset by three members in the fourth subset.

9. An apparatus according to any of claims 1 to 5, in which the members of the third subset are randomly arranged along the ramp.

10. An apparatus according to any preceding claim, in which:
the ramp is arranged to act as one of: a lead-on ramp arranged so that the vehicle can drive onto the raised section via the lead-on ramp; and a lead-off ramp arranged so that the vehicle can drive off the raised section via the lead-off ramp; and
the trackway comprises a second ramp which is arranged to act as the other of the lead-on ramp or lead-off ramp.

11. An apparatus according to claim 10, in which:
the second ramp comprises a third set of the transversely extending members; and
the third set of the transversely extending members comprises a fifth subset and a sixth subset of transversely extending members, in which the transversely extending members of the fifth subset are raised with respect to those in the sixth subset.

12. An apparatus according to claim 11, in which the members in the fifth subset are regularly arranged along the ramp.

13. An apparatus according to claim 12, in which each member in the fifth subset is separated from another member in the fifth subset by members in the sixth subset.

14. An apparatus according to claim 7, in which the each member in the fifth subset is separated from another member in the fifth subset by three members in the sixth subset.

15. An apparatus according to claim 11, in which the members of the fifth subset are randomly arranged along the second ramp.

16. An apparatus according to any of claims 11 to 15, in which the height difference between the members in the third subset and the members in the fourth subset is the same as the height difference between the members in the fifth subset and the members in the sixth subset.

17. An apparatus according to any of claims 11 to 15, in which the height difference between the members in the third subset and the members in the fourth subset is different from the height difference between the members in the fifth subset and the members in the sixth subset.

18. An apparatus according to any preceding claim, in which an amount the members in the first subset are raised with respect to the members in the second subset is different from the height difference between the members in the third subset and the members in the fourth subset.

19. An apparatus according to claim 18, in which the amount the members in the first subset is raised with respect to the members in the second subset is greater than the height difference between the members in the third subset and the members in the fourth subset.

20. An apparatus according to any preceding claim, comprising side barriers for inhibiting movement of the vehicle off the sides of the trackway.

21. An apparatus according to claim 20, in which the side barriers comprise a plurality of welded box section metal tubes.

22. An apparatus according to claim 20 or 21, in which the trackway comprises a plurality of brackets along the sides of the trackway and arranged so that a portion of the side barriers can be slotted into the brackets to mount the side barriers on the trackway.

23. An apparatus according to any preceding claim, in which the apparatus comprises modular sections.

24. An apparatus according to any preceding claim, in which the trackway comprises a pair of tracks in generally parallel spaced relation to each other.

25. An apparatus according to any preceding claim, in which one or more of the raised section and the ramp are open beneath for allowing matter to fall between the transversely extending members.

26. An apparatus according to any preceding claim, in which the members in the first subset are raised between 35 mm to 45 mm with respect to the members in the second subset.

27. An apparatus according to claim 26, in which the members in the first subset are raised by 40 mm with respect to the members in the second subset.

28. An apparatus according to any preceding claim in which an upper portion of the cross section of the members is substantially v-shaped with the apex directed upwards for making line contact with the tyres of the vehicle.

29. An apparatus or method substantially as hereinbefore described.
